(19) United States
(12) Patent Application Publication
(10) Pub. No.: US 2018/0015785 A1
(43) Pub. Date: Jan. 18, 2018

(54) NON-PNEUMATIC TIRE ASSEMBLY INCLUDING A REPLACEABLE TREAD ELEMENT

(71) Applicant: Bridgestone Americas Tire Operations, LLC, Nashville, TN (US)

(72) Inventor: Jon I. Stuckey, Uniontown, OH (US)

(21) Appl. No.: 15/675,863

(22) Filed: Aug. 14, 2017

Related U.S. Application Data
(63) Continuation-in-part of application No. 14/624,297, filed on Feb. 17, 2015, now Pat. No. 9,731,558.
(60) Provisional application No. 61/946,718, filed on Mar. 1, 2014.

(51) Int. Cl. B60C 7/24; B60C 11/02; B60C 7/12

(52) U.S. Cl. CPC B60C 7/24; B60C 7/125; B60C 11/02

(57) ABSTRACT

Various embodiments of a non-pneumatic tire assembly including a replaceable tread element are disclosed. In one embodiment, a tire assembly is provided, the tire assembly comprising: a non-pneumatic tire having: a rim portion, an outer ring oriented radially outward of the rim portion, and a web structure connecting the rim portion and the outer ring; an inner tread band oriented radially outwardly of the non-pneumatic tire and connected to a radially outer side of the outer ring; and an outer tread oriented radially outwardly of the inner tread band and connected to the inner tread band.

### CROSS-REFERENCE TO RELATED APPLICATIONS

This application claims priority as a continuation-in-part application to U.S. patent application Ser. No. 14/624,297, filed on Feb. 17, 2015, which claims priority to U.S. Patent Application No. 61/946,718, filed on Mar. 1, 2014, each of which is incorporated by reference herein in its entirety.

### BACKGROUND

Tires on vehicles may be exposed to a variety of road conditions. For example, a tire may be exposed to road conditions such as: dry, wet, snowy, icy, muddy, etc. Certain tread patterns, compounds, block stiffness, and other qualities of the tire's tread may be best suited for any particular condition. However, in an effort to make tires that are applicable across a variety of conditions, or seasons of the year, many tire manufacturers optimize parameters so as to make tires that perform decently in a variety of conditions.

As a result, a consumer operating a vehicle in a variety of road conditions, and/or seasonal conditions, may have to have their vehicle's tires swapped out with tires better suited for a particular condition. However, dismounting tires from a rim, and remounting other tires is not a simple task.

Additionally, tires often wear only in the tread and shoulder regions of the tire. As a result, a tire that is worn to the point that it must be replaced may still be suitable for use, with exception to its tread and shoulder regions. Some consumers opt to have tires retreaded, wherein the worn tread and shoulder regions of the tire are replaced. However, such retreading is a specialized service and not a simple task.

Also, non-pneumatic tires are increasing in popularity, including non-pneumatic tires that are composite in nature. For example, many non-pneumatic tires include a polymer (e.g., a plastic) web structure radially between the hub area and tread area of the tire. Radially outwardly of the polymer web structure may be a rubber tread structure.

What is needed is a tire assembly having an easily replaceable radially outer tread portion.

### SUMMARY

In one embodiment a tire assembly is provided, the tire assembly comprising: a non-pneumatic tire having: a rim portion, an outer ring oriented radially outward of the rim portion, and a web structure connecting the rim portion and the outer ring; an inner tread band oriented radially outwardly of the non-pneumatic tire and connected to a radially outer side of the outer ring; and an outer tread oriented radially outwardly of the inner tread band and connected to the inner tread band.

In another embodiment a tire assembly is provided, the tire assembly comprising: a non-pneumatic tire having: a rim portion, an outer ring oriented radially outward of the rim portion, and a web structure connecting the rim portion and the outer ring; an inner tread band oriented radially outwardly of the non-pneumatic tire and connected to a radially outer side of the outer ring; and an outer tread oriented radially outwardly of the inner tread band and connected to the inner tread band, wherein the outer tread is connected to the inner tread band by a friction fit.

In another embodiment a tire assembly is provided, the tire assembly comprising: a non-pneumatic tire having: a rim portion, an outer ring oriented radially outward of the rim portion, wherein the outer ring has a radially outer surface and axially outermost edges, wherein the outer ring has at least one of: at least one transverse groove on its radially outer surface, at least one circumferential groove on its radially outer surface, and circumferential filleted edges at its axially outermost edges, and a web structure connecting the rim portion and the outer ring; and an outer tread oriented radially outwardly of the outer ring and connected to the outer ring, wherein the outer tread is connected to the outer ring by a friction fit, wherein the outer tread has a radially inner surface and axially outermost edges, wherein the outer tread has at least one of: at least one transverse ridge on its radially inner surface, at least one circumferential ridge on its radially inner surface, and circumferential wing elements extending radially inwardly at its axially outermost edges.

### BRIEF DESCRIPTION OF THE DRAWINGS

The accompanying figures, which are incorporated in and constitute a part of the specification, illustrate various example configurations, and are used merely to illustrate various example embodiments. In the figures, like elements bear like reference numerals.

FIG. 1A illustrates a perspective view of an example embodiment of a tire assembly including a non-pneumatic tire, inner tread band, and outer tread.

FIG. 1B illustrates a perspective view of an example embodiment of a tire assembly including a non-pneumatic tire, inner tread band, and outer tread.

FIG. 1C illustrates a perspective view of an example embodiment of a tire assembly including a non-pneumatic tire.

FIG. 2A illustrates a perspective view of an example embodiment of a tire assembly including a non-pneumatic tire, inner tread band, and outer tread.

FIG. 2B illustrates a perspective view of an example embodiment of a tire assembly including a non-pneumatic tire, inner tread band, and outer tread.

FIG. 2C illustrates a perspective view of an example embodiment of a tire assembly including a non-pneumatic tire, inner tread band, and outer tread.

FIG. 2D illustrates a perspective view of an example embodiment of a tire assembly including a non-pneumatic tire, and an inner tread band.

FIG. 3 illustrates a perspective view of an example embodiment of an inner tread band.

FIG. 4 illustrates a perspective view of an example embodiment of a tire assembly including an inner tread band and an outer tread.

FIG. 5 illustrates a sectional view of an example embodiment of a tire assembly including an inner tread band and an outer tread.

FIG. 6 illustrates a sectional view of an example embodiment of a tire assembly including an inner tread band and an outer tread.

### DETAILED DESCRIPTION

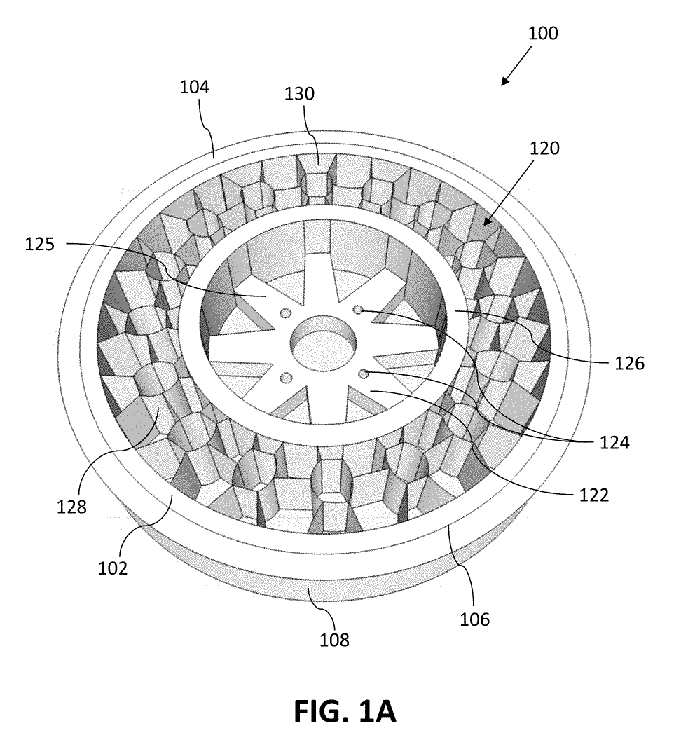

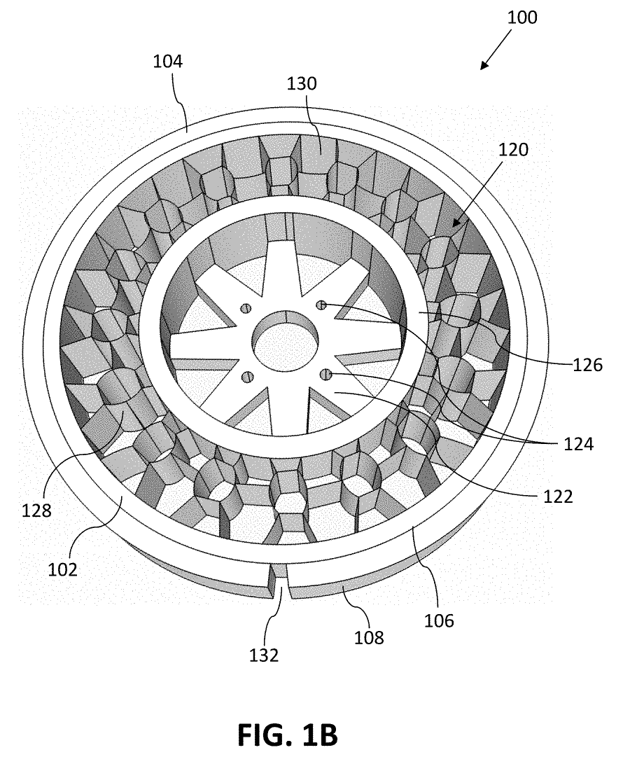

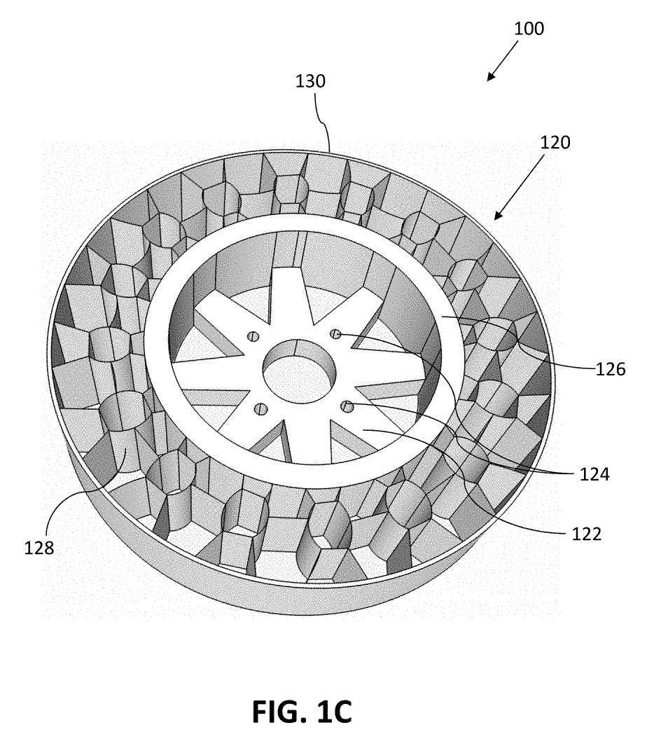

FIGS. 1A-1C illustrate example embodiments of a tire assembly 100 including a non-pneumatic tire 120, an inner tread band 102, and an outer tread 104. Inner tread band 102 may be oriented radially outwardly of non-pneumatic tire 120. Outer tread 104 may be oriented radially outwardly of inner tread band 102. In one embodiment, inner tread band 102 is eliminated, and outer tread 104 directly contacts non-pneumatic tire 120.

Non-pneumatic tire 120 may include an inner hub portion 122 including at least one lug hole 124. Non-pneumatic tire 120 may include spokes 125 connecting hub portion 122 to a rim portion 126. Non-pneumatic tire 120 may include a web structure 128. Web structure 128 may connect rim portion 126 to an outer ring 130. Web structure 128 and outer ring 130 may flex upon loading and operation, thus emulating the function of a pneumatic tire during loading and operation. Web structure 128 may include a plurality of interconnected substantially flat elements configured to bend and flex, both internally and relative to one another at junctions where each connects to another.

Inner hub portion 122 may be made from any of a variety of materials, including for example, a metal, an alloy, a polymer, and the like.

Web structure 128 may be made from any of a variety of materials, including for example, a polymer, a metal, an alloy, a composite, and the like.

Outer ring 130 may be made from any of a variety of materials, including for example, a polymer, a metal, an alloy, a composite, and the like.

Inner tread band 102 may be made from any of a variety of materials, including for example, a polymer, a rubber, and the like.

Outer tread 104 may be made from any of a variety of materials, including for example, a rubber, a polymer, and the like. Outer tread 104 may include a tread pattern (not shown) on its running surface 108, similar to a conventional tire intended for operation on a vehicle.

Inner tread band 102 may be connected to a radially outer side of outer ring 130. Inner tread band 102 may be connected to outer ring 130 using an adhesive. Inner tread band 102 may be connected to outer ring 130 using a friction fit. Inner tread band 102 may be connected to outer ring 130 using a friction fit and an adhesive. Inner tread band 102 may be a pre-formed ring. The adhesive may be any of a variety of adhesives, including for example, an epoxy.

In practice, the diameter of outer ring 130 may be decreased by locking inner hub portion 122 to a mounting structure, placing elements of the mounting structure (e.g., rods) through holes in web structure 128, and rotating the elements of the mounting structure engaging web structure 128 relative to inner hub portion 122, about an axis that is collinear with the axial axis of tire assembly 100. This rotation of the elements engaging web structure 128 relative to inner hub portion 122 will cause web structure 128 to partially collapse, which in turn will cause outer ring 130 to decrease in diameter.

Upon the decrease in diameter of outer ring 130, inner tread band 102 may be applied to outer ring 130, with or without an adhesive. Upon mounting of inner tread band 102, the mounting structure elements engaging web structure 128 may be rotated relative to inner hub portion 122 back to a starting position, which will cause web structure 128 to expand (e.g., the opposite of collapsing), which in turn will cause outer ring 130 to return to its approximate original diameter (e.g., before application of non-pneumatic tire 120 to the mounting structure. Where inner tread band 102 is designed with an inner diameter smaller than the outer diameter of outer ring 130, allowing outer ring 130 to expand back to its approximate original diameter will cause inner tread band 102 to be placed in a state of tension, much like a rubber band stretched and placed over a cylinder. As a result, inner tread band 102 may engage outer ring 130 with a friction fit (also known as an interference fit).

The torque required to rotate web structure 128 relative to inner hub portion 122 to decrease the diameter of outer ring 130 must be greater than the maximum torque that tire assembly 100 may experience in a braking or acceleration incident.

In one embodiment, outer tread 104 is likewise applied to the radially outer portion of inner tread band 102 during “collapse” of non-pneumatic tire 120, and is similarly friction fit radially outwardly of inner tread band 102. In this embodiment, outer tread 104 may be a pre-formed ring. Outer tread 104 may have an inner diameter that is smaller than the outer diameter of inner tread band 102 after inner tread band 102 is mounted on non-pneumatic tire 120. Similarly, outer tread 104 and/or inner tread band 102 may be dismounted from non-pneumatic tire 120 by rotation of web structure 128 relative to inner hub portion 122.

Outer tread 104 may be wound onto inner tread band 102, wherein outer tread 104 begins as a linear element, and is rolled onto inner tread band 102, with the ends of outer tread 104 being adhered together at a splice.

Outer tread 104 may be applied to the exterior of inner tread band 102 to form a tread interface 106. An adhesive may be applied in tread interface 106. A sealant may be applied in tread interface 106. Tread interface 106 may include an adhesive and/or a sealant to prevent moisture, debris, and the like from entering tread interface 106.

Outer tread 104 may be the wear portion of tire assembly 100. Outer tread 104 may be replaceable upon wear of running surface 108, damage to outer tread 104, and the like. That is, a first outer tread 104 may be removed from tire assembly 100 and replaced with a second outer tread 104.

As illustrated in FIG. 1B, when one desires to remove outer tread 104 from inner tread band 102, outer tread 104 may be incised transversely across the width of outer tread 104, for example at incision 132. One may accordingly peel outer tread 104 away from inner tread band 102 and completely remove outer tread 104 from tire assembly 100.

FIG. 1C illustrates non-pneumatic tire 120 of tire assembly 100, where both outer tread 104 and inner tread band 102 have been removed, or alternatively, prior to application of inner tread band 102 and outer tread 104.

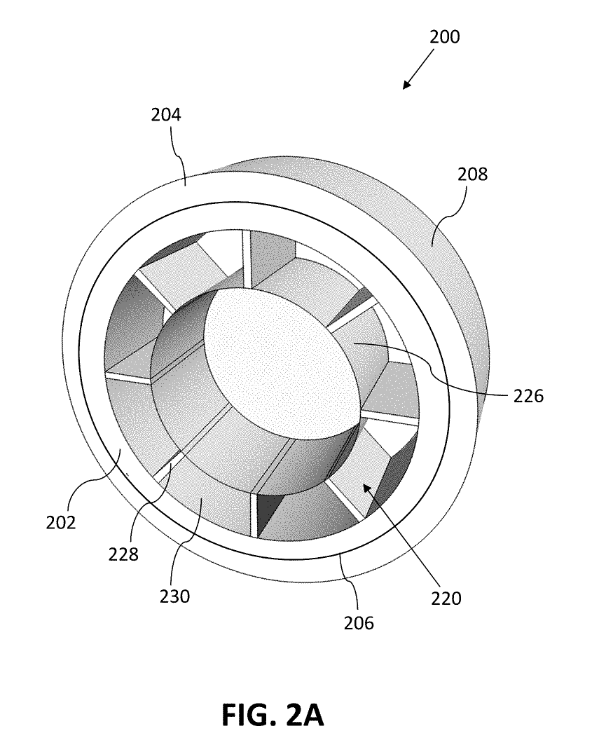

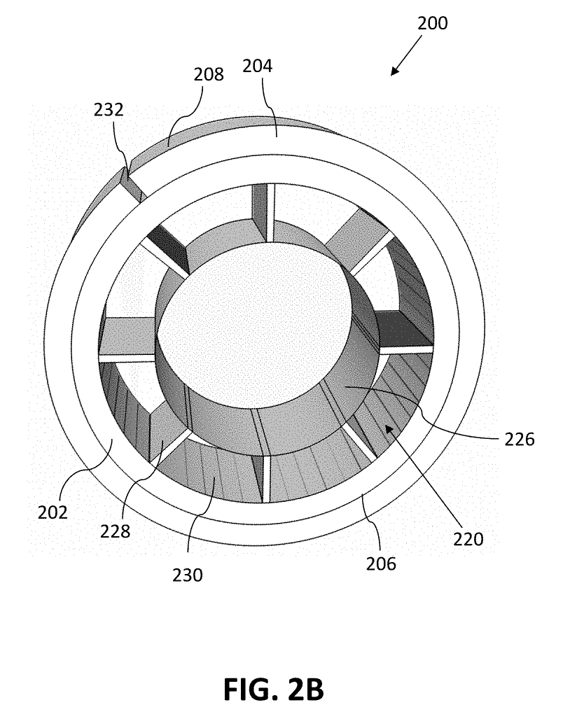

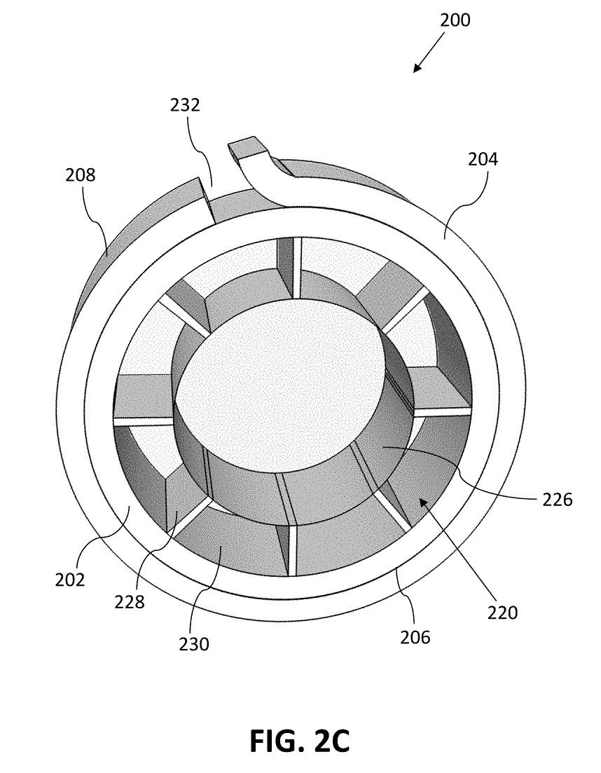

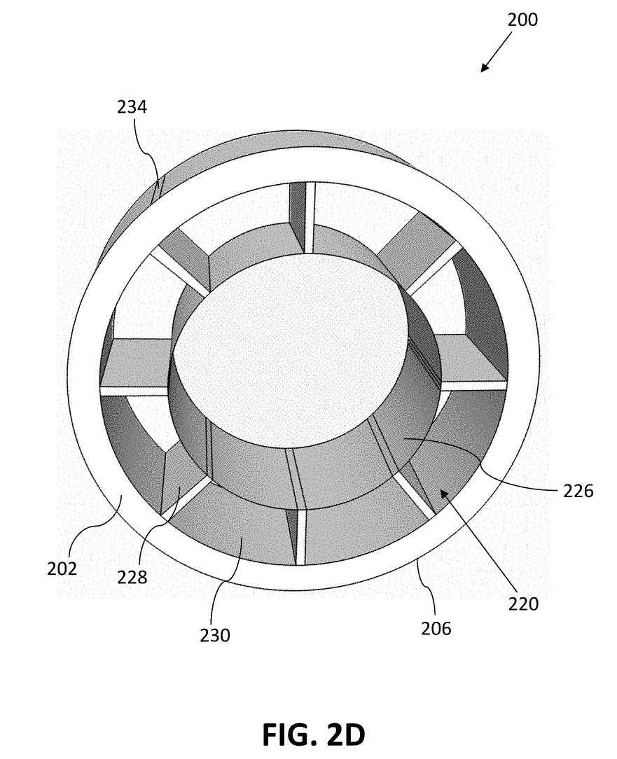

FIGS. 2A-2D illustrate example embodiments of a tire assembly 200 including a non-pneumatic tire 220, inner tread band 202, and outer tread 204.

Non-pneumatic tire 220 may include a rim portion 226. Non-pneumatic tire 220 may include a web structure 228. Web structure 228 may connect rim portion 226 to an outer ring 230. Web structure 228 and outer ring 230 may flex upon loading and operation, thus emulating the function of a pneumatic tire during loading and operation.

Inner tread band 202 may be oriented radially outwardly of non-pneumatic tire 220, and may engage outer ring 230. Outer tread 204 may be oriented radially outwardly of inner tread band 202. In one embodiment, inner tread band 202 is eliminated, and outer tread 204 directly contacts non-pneumatic tire 220, and engages outer ring 230.

As illustrated in FIG. 2B, outer tread 204 may be removed via incising outer tread 204 at incision 232. Outer tread 204 may be incised completely through its radial thickness, and across the entirety of its transverse width.

As illustrated in FIG. 2C, outer tread 204 may be peeled away from inner tread band 202.

As illustrated in FIG. 2D, outer tread 204 may be completely removed from tread band 202. A cut-resistant strip 234 may be oriented in tread interface 206 where outer tread 204 is to be incised. Cut-resistant strip 234 may be configured to prevent accidental cutting into inner tread band 202 during incising of outer tread 204. Cut-resistant strip 234 may be a polymer having greater hardness than outer tread 204, a metallic element, a composite material, and the like. The location of cut-resistant strip 234 may be indicated on the side of outer tread 204 and/or inner tread band 202. Thus, one removing outer tread 204 may be directed to incise outer tread 204 at the location of cut-resistant strip 234. Cut-resistant strip 234 may be visible from the side of tire assembly 200, and thus, one removing outer tread 204 may align incision 232 with cut-resistant strip 234. Cut-resistant strip 234 may extend across the transverse width of inner tread band 202. Alternatively, cut-resistant strip 234 may be integrally formed with inner tread band 202, and may appear through a portion of, or all of, the radial thickness of tread band 202. Cut-resistant strip 234 may be an area of reinforcement, preventing inadvertent incision of inner tread band 202 during incising of outer tread 204.

Cut-resistant strip 234 may include a material having insulative properties, thus preventing or mitigating the transfer of heat from outer tread 204 into inner tread band 202 during incision of outer tread 204. For example, one may use a power tool, such as a saw, to incise outer tread 204, and the action of incising outer tread 204 may generate heat in outer tread 204. Alternatively, one may use a hot-wire to incise outer tread 204, which generates heat in outer tread 204.

As discussed above, outer tread 204 may have a running surface 208 with a tread pattern (not shown) similar to conventional tires used on a vehicle.

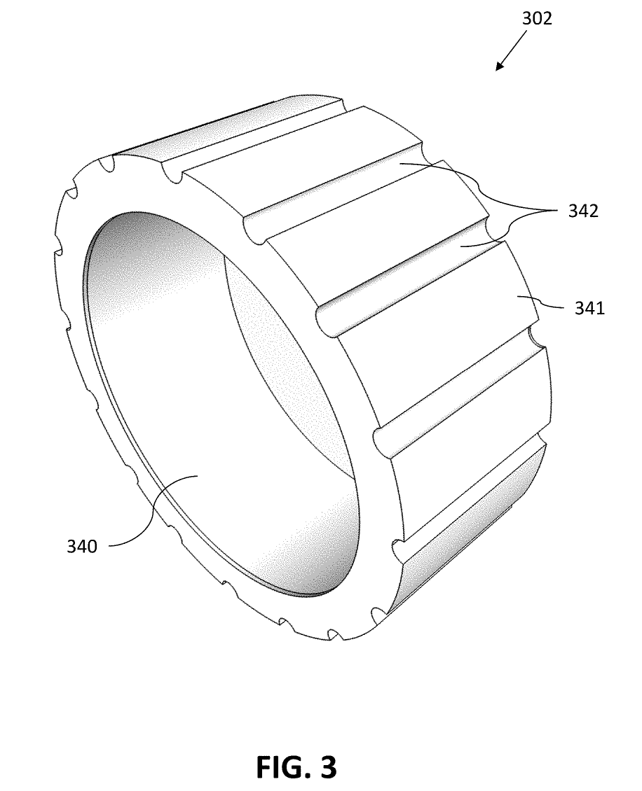

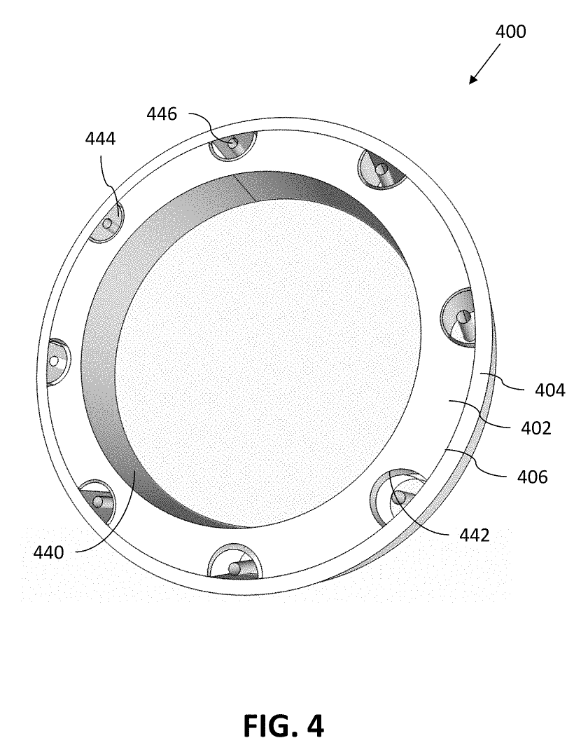

FIG. 3 illustrates an example embodiment of an inner tread band 302. Inner tread band 302 may include a radially inner surface 340 configured to engage a non-pneumatic tire (not shown). Inner tread band 302 may have a radially outer surface 341 configured to engage an outer tread (not shown). Inner tread band 302 may include transverse grooves 342 extending partially or completely transversely across radially outer surface 341. Transverse grooves 342 may be oriented at regular circumferential intervals. Transverse grooves 342 may be configured to accept transverse ridges (illustrated in FIG. 4) extended from an outer tread.

Alternatively, transverse grooves 342 may be oriented at irregular circumferential intervals, requiring rotational alignment between inner tread band 302 and an outer tread having corresponding transverse ridges.

Alternatively, inner tread band 302 may include a single transverse groove, requiring rotational alignment between inner tread band 302 and an outer tread having a single corresponding ridge.

FIG. 4 illustrates an example embodiment of a tire assembly 400 including an inner tread band 402 and an outer tread 404, which may engage one another at a tread interface 406.

Inner tread band 402 may include a radially inner surface 440. Inner tread band 402 may include at least one transverse groove 442.

Outer tread 404 may include at least one transverse ridge 444. Outer tread 404 and inner tread band 402 may be paired, and rotationally aligned, so as to ensure that each transverse ridge 444 has a corresponding transverse groove 442, and such that each transverse ridge 444 engages a transverse groove 442.

Each transverse ridge 444 may include a reinforcement element 446 to provide strength to transverse ridge 444. Reinforcement element 446 may include any of a variety of materials, including for example: a metallic cable (e.g., solid metal wire or a braided wire rope), a hollow tube, a carbon fiber rod, a carbon fiber hollow tube, a composite material, a textile material, metallic wire (solid or braided) surrounded by a rubber material (e.g., similar to a traditional tire bead), a polymer material, an aramid material, a nylon material, and the like. Reinforcement element 446 may be flexible along its length, such that it may deform under load, similar to a simply-supported beam. Reinforcement element 446 may function to give structural integrity to transverse ridge 444, so as to ensure that transverse ridge 444 remains engaged with transverse groove 442.

In one embodiment, a fabric material, such as a textile, may extend circumferentially within tread interface 406. The fabric material may be adhered to, or integrally formed with, outer tread 404 or inner tread band 402, or both. The fabric material may extend completely across the transverse width of outer tread 404, or inner tread band 402. In one embodiment, each transverse ridge 444 does not include reinforcement element 446, but rather, the radially inner surface of outer tread 404 is coated with a fabric, and the fabric is configured to provide structural integrity to transverse ridge 444. In one embodiment, outer tread 404 includes both reinforcement elements 446 and a fabric lining.

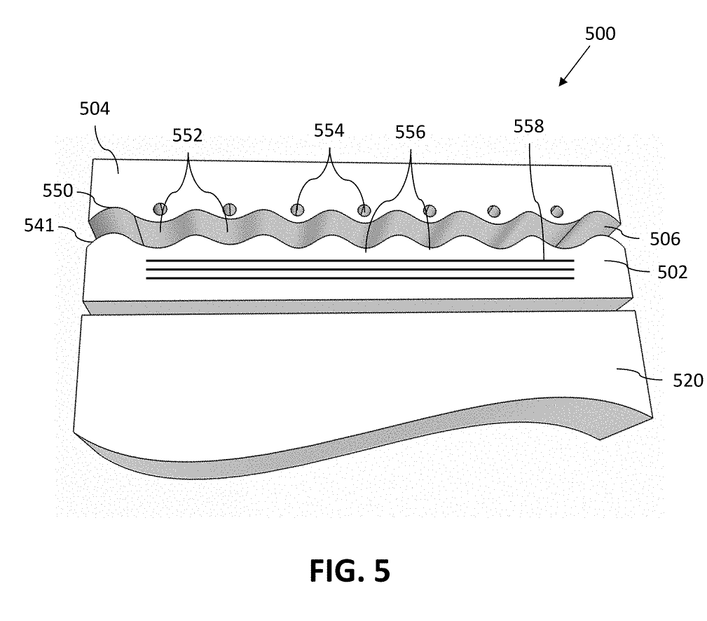

FIG. 5 illustrates an example embodiment of a tire assembly 500 including an inner tread band 502 and an outer tread 504. It is understood that FIG. 5 illustrates a sectional view, taken about a line extending transversely/axially across a portion of a tire assembly. That is, the circumferential direction is into the drawing page. Inner tread band 502 and outer tread 504 may engage one another at a tread interface 506. Inner tread band 502 may engage a non-pneumatic tire 520.

Inner tread band 502 may include at least one circumferential belt 558. Inner tread band 502 may operate as a shear hoop in tire assembly 500 (and any tire assemblies discussed above). Belts 558 may be similar to traditional belts found in pneumatic tires. Belts 558 may be made of any of a variety of materials, including steel, a textile, a polymer, a composite, and the like. Belts 558 may be circumferentially inextensible, and may provide circumferential strength to inner tread band 502 and tire assembly 500 (and any tire assemblies discussed above).

Inner tread band 502 may include a radially outer surface 541. Outer tread 504 may include a radially inner surface 550.

Outer tread 504 may include at least one circumferential ridge 552 on its radially inner surface 550. Each circumferential ridge 552 may correspond to at least one circumferential groove 556 on radially outer surface 541 of inner tread band 502. The profile of tread interface 506 may extend transversely in a sinusoidal shape.

Each of circumferential ridges 552 may include a circumferential reinforcement element 554. Reinforcement element 554 may include any of a variety of materials, including for example: a metallic cable (e.g., solid metal wire or a braided wire rope), a hollow tube, a carbon fiber rod, a carbon fiber hollow tube, a composite material, a textile material, metallic wire (solid or braided) surrounded by a rubber material (e.g., similar to a traditional tire bead), a polymer material, an aramid material, a nylon material, and the like.

Reinforcement element 554 may provide circumferential strength to outer tread 504, and tire assembly 500 (and any tire assemblies discussed above). Reinforcement element 554 may be inextensible. Reinforcement element 554 may provide structural integrity to circumferential ridge 552, so as to ensure that circumferential ridge 552 does not deform and become disengaged from circumferential groove 556.

Engagement of circumferential ridges 552 and circumferential grooves 556 may prevent axial shifting of outer tread 504 relative to inner tread band 502.

It is understood that a tire assembly may include both circumferential grooves/ridges, and transverse grooves/ridges, so as to create a tread interface that prevents both axial shifting and circumferential slipping of an outer tread relative to an inner tread band.

Alternatively, a tire assembly may include only one of circumferential grooves/ridges and transverse grooves/ridges.

Where a tire assembly includes at least one circumferential groove/ridge, without transverse grooves/ridges, the tire assembly (namely, the outer tread and inner tread band) may be designed so as to ensure a friction coefficient between the outer tread and the inner tread band sufficient to result in a circumferential friction force between the outer tread and the inner tread band that is greater than the maximum forces experienced at the running surface of the outer tread during braking and acceleration, accounting for the thickness of the outer tread and the effect of that thickness to act as a lever arm.

Where the tire assembly includes at least one transverse groove/ridge, without circumferential grooves/ridges, the tire assembly (namely, the outer tread and the inner tread band) may be designed so as to ensure a friction coefficient between the outer tread and the inner tread band sufficient to result in an axial friction force between the outer tread and the inner tread band that is greater than the maximum forces experienced at the running surface of the outer tread during cornering.

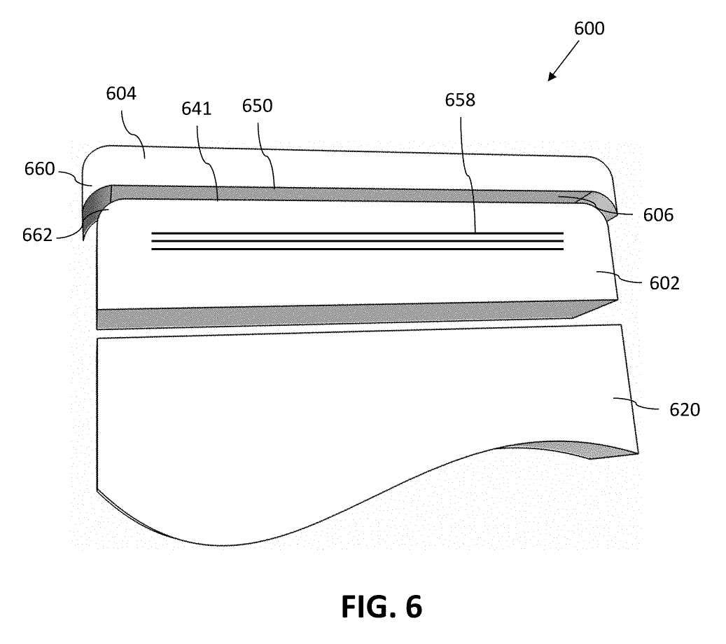

FIG. 6 illustrates an example embodiment of a tire assembly 600 including an inner tread band 602 and an outer tread 604. It is understood that FIG. 6 illustrates a sectional view, taken about a line extending transversely/axially across a portion of a tire assembly. That is, the circumferential direction is into the drawing page. Inner tread band 602 and outer tread 604 may engage one another at a tread interface 606. Inner tread band 602 may engage a non-pneumatic tire 620.

Inner tread band 602 may include at least one circumferential belt 658. Inner tread band 602 may operate as a shear hoop in tire assembly 600 (and any tire assemblies discussed above). Belts 658 may be similar to traditional belts found in pneumatic tires. Belts 658 may be made of any of a variety of materials, including steel, a textile, a polymer, a composite, and the like. Belts 658 may be circumferentially inextensible, and may provide circumferential strength to inner tread band 602 and tire assembly 600 (and any tire assemblies discussed above).

Inner tread band 602 may include a radially outer surface 641. Outer tread 604 may include a radially inner surface 650. Outer tread 604 may have an inner surface 650 that is at least partially concave, with circumferential wing elements 660 extending radially inwardly at or near the axially outermost edges of outer tread 604. Inner tread band 602 may have a radially outer surface 641 that is at least partially convex, with circumferential filleted or chamfered edges 662 at or near the axially outermost edges of inner tread band 602. In this manner, outer tread 604 may engage inner tread band 602, such that wing elements 660 axially enclose edges 662, thus preventing axial shifting of outer tread 604 relative to inner tread band 602.

It is understood that a tire assembly may include both circumferential wing elements/edges and transverse grooves/ridges, so as to create a tread interface that prevents both axial shifting and circumferential slipping of an outer tread relative to an inner tread band.

Alternatively, a tire assembly may include only one of circumferential wing elements/edges and transverse grooves/ridges. As discussed above, where a tire assembly includes one, but not the other, the outer tread and inner tread band may be designed to provide friction forces therebetween greater than the forces that the tire will experience during acceleration, braking, cornering, and the like.

In any of the embodiments disclosed above, the inner tread band may be eliminated. In such embodiments, shape features of the inner tread band (e.g., circumferential grooves, rounded edges, and transverse grooves) may be instead added to the outer ring of the non-pneumatic tire (e.g., outer ring 130). Belts may be added to the outer tread to provide circumferential strength to the tire assembly. A cut-resistant strip (e.g., cut-resistant strip 234) may be added to the outer ring of the non-pneumatic tire. In this manner, the outer tread may be applied directly to the outer ring of the non-pneumatic tire.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available or prudent in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. A tire assembly, comprising:
a non-pneumatic tire having:
a rim portion,
an outer ring oriented radially outward of the rim portion, and
a web structure connecting the rim portion and the outer ring;
an inner tread band oriented radially outwardly of the non-pneumatic tire and connected to a radially outer side of the outer ring; and
an outer tread oriented radially outwardly of the inner tread band and connected to the inner tread band.

2. The tire assembly of claim 1, wherein the inner tread band is connected to the radially outer side of the outer ring by an adhesive.

3. The tire assembly of claim 1, wherein the outer tread is connected to the inner tread band by a friction fit.

4. The tire assembly of claim 1, wherein the outer tread is a pre-formed ring.

5. The tire assembly of claim 1, wherein a cut-resistant strip is oriented between the inner tread band and the outer tread, wherein the cut-resistant strip extends across a transverse width of the inner tread band.

6. The tire assembly of claim 1, wherein the inner tread band has at least one transverse groove on its radially outer surface, wherein the outer tread has at least one transverse ridge on its radially inner surface, and wherein the at least one transverse ridge engages the at least one transverse groove.

7. The tire assembly of claim 6, wherein each transverse ridge includes a reinforcement element.

8. The tire assembly of claim 1, wherein the inner tread band has at least one circumferential groove on its radially outer surface, wherein the outer tread has at least one circumferential ridge on its radially inner surface, and wherein the at least one circumferential ridge engages the at least one circumferential groove.

9. The tire assembly of claim 8, wherein each circumferential ridge includes a reinforcement element.

10. The tire assembly of claim 1, wherein the inner tread band has axially outermost edges, wherein the inner tread band has circumferential filleted edges at its axially outermost edges, wherein the outer tread has axially outermost edges, wherein the outer tread has circumferential wing elements extending radially inwardly at its axially outermost edges, and wherein the wing elements engage the filleted edges.

11. A tire assembly, comprising:
a non-pneumatic tire having:
a rim portion,
an outer ring oriented radially outward of the rim portion, and
a web structure connecting the rim portion and the outer ring;
an inner tread band oriented radially outwardly of the non-pneumatic tire and connected to a radially outer side of the outer ring; and
an outer tread oriented radially outwardly of the inner tread band and connected to the inner tread band, wherein the outer tread is connected to the inner tread band by a friction fit.

12. The tire assembly of claim 11, wherein the inner tread band is connected to the radially outer side of the outer ring by an adhesive.

13. The tire assembly of claim 11, wherein the outer tread is a pre-formed ring.

14. The tire assembly of claim 11, wherein a cut-resistant strip is oriented between the inner tread band and the outer tread, wherein the cut-resistant strip extends across a transverse width of the inner tread band.

15. The tire assembly of claim 11, wherein the inner tread band has at least one transverse groove on its radially outer surface, wherein the outer tread has at least one transverse ridge on its radially inner surface, and wherein the at least one transverse ridge engages the at least one transverse groove.

16. The tire assembly of claim 15, wherein each transverse ridge includes a reinforcement element.

17. The tire assembly of claim 11, wherein the inner tread band has at least one circumferential groove on its radially outer surface, wherein the outer tread has at least one circumferential ridge on its radially inner surface, and wherein the at least one circumferential ridge engages the at least one circumferential groove.

18. The tire assembly of claim 17, wherein each circumferential ridge includes a reinforcement element.

19. The tire assembly of claim 11, wherein the inner tread band has axially outermost edges, wherein the inner tread band has circumferential filleted edges at its axially outermost edges, wherein the outer tread has axially outermost edges, wherein the outer tread has circumferential wing elements extending radially inwardly at its axially outermost edges, and wherein the wing elements engage the filleted edges.

20. A tire assembly, comprising:
a non-pneumatic tire having:
a rim portion,
an outer ring oriented radially outward of the rim portion,
wherein the outer ring has a radially outer surface and axially outermost edges,
wherein the outer ring has at least one of: at least one transverse groove on its radially outer surface, at least one circumferential groove on its radially outer surface, and circumferential filleted edges at its axially outermost edges, and
a web structure connecting the rim portion and the outer ring; and
an outer tread oriented radially outwardly of the outer ring and connected to the outer ring,
wherein the outer tread is connected to the outer ring by a friction fit,
wherein the outer tread has a radially inner surface and axially outermost edges,
wherein the outer tread has at least one of: at least one transverse ridge on its radially inner surface, at least one circumferential ridge on its radially inner surface, and circumferential wing elements extending radially inwardly at its axially outermost edges.
